(19) United States
(12) Patent Application Publication
(10) Pub. No.: US 2019/0219838 A1
(43) Pub. Date: Jul. 18, 2019

(54) DISMOUNTABLE FRAME FOR GLASSES

(71) Applicant: Fabrizio PADRIN, Vicenza (IT)

(72) Inventor: Fabrizio PADRIN, Vicenza (IT)

(21) Appl. No.: 16/311,686

(22) PCT Filed: Feb. 8, 2017
(86) PCT No.: PCT/IB2017/050668

§ 371 Date: Dec. 20, 2018

(30) Foreign Application Priority Data
Jun. 20, 2016 (IT) 202016000063233

(51) Int. Cl. G02C 1/08; G02C 1/00

(52) U.S. Cl. CPC G02C 1/08; G02C 5/2209; G02C 1/10

(57) ABSTRACT

A dismountable frame for glasses comprises a frontal chassis (2) having a pair of circles (3, 4) for housing respective lenses, a pair of rods (5, 6) mounted laterally to the chassis (2) from opposite sides with respect thereto, means for removably fixing the rods (5, 6) to the chassis (2) comprising a pair of end pieces (8) each having a first shaped portion (9) with jointing means (10) adapted to be removably inserted and fitted in corresponding counter-shaped lateral seats (11) of the chassis (2), the latter being provided with a pair of through cuts (12, 13) made in each of the lateral counter-shaped seats (11) to allow the enlargement of the circles (3, 4) in the absence of the end pieces (8).

### TECHNICAL FIELD

The present invention finds application in the technical field of optics and has particularly for object a dismountable frame for glasses.

### STATE OF THE ART

As known, the typical frame for glasses, both eyeglasses and sunglasses, comprise a shaped frontal chassis provided with two circles for housing the lenses and having a central bridge that lies on the nose.

Laterally, the chassis has two rods hinged to blocks or end pieces to be rotated between an operating position orthogonal to the chassis for resting on the user's ear to a position parallel to the chassis and adapted to allow the glasses to be stored.

The blocks or end pieces may be either of the same material of the chassis or in different materials, such as metal, resin or other polymeric materials, and typically it is integral or otherwise fixed to the chassis so as to be not removed or modified.

The hinging modes of the rods to the end pieces may vary depending on models and may require the use of screws, pins or push couplings.

On the market, it is also possible to find models wherein the rods are made as one piece and are applied directly on the chassis without a real mechanical joint.

Other solutions on the market allow the rod to be removed and replaced with other rods of the same type but with different colours.

However, even in these cases the rods are designed to be applied in the chassis which is still formed by a single body which does not allow to operate on the lenses that, instead, remain firmly placed in the chassis.

Consequently, if there is the need or in any case the desire to remove and replace lenses, or only one of them, it is necessary to carry out specific operations which are usually entrusted, in particular in the case of lenses for eyeglass, only and exclusively to a specialized optical technician.

In particular, with plastic or resin frames it is necessary to heat the chassis to force out the lenses, while in the case of metal frames it is necessary to remove the screw or pin at the hinge.

These steps still require time and a certain expertise and therefore it is risky to make them by himself because there is a risk of damage the lenses or the frame.

Furthermore, it is essential to reposition the lens properly and executes the correct centering, which represents a peculiar feature for eyeglasses.

Other solutions provide that the mounting frame has two circles for housing the lenses which are open at the bottom to remove the lenses simply by pulling downwards.

However, the lens is not adequately protected along its whole perimeter and moreover with time a deformation of the frame, even limited, may occur which does not allow the lenses to remain stable in position.

### SCOPE OF THE INVENTION

The object of the present invention is to overcome the above mentioned drawbacks, by providing a dismountable frame for glasses characterized by high efficiency and relative cheapness.

A particular object is to provide a dismountable frame for glasses that allows the lenses to be removed and replaced in a quick and simple manner and without requiring particular expertise, being able to be performed even by non-expert people.

Still another object of the present invention is to provide a dismountable frame for glasses that can be customized in its various parts by the user in a simple and quick manner, also by limiting costs when the optical lenses should be replaced for a different prescription.

Still another object of the present invention is to provide a dismountable frame for glasses that always guarantees high protection and stability for the lenses applied to the frame, preserving all the compliance features needed for eyeglasses and sunglasses to not create damage or inconvenience to the user.

These objects, as well as others which will become more apparent hereinafter, are achieved by a dismountable frame for glasses that, according with claim 1, comprises a frontal chassis having a pair of circles for housing respective lenses, a pair of rods mounted laterally to said chassis, means for the removable fixing of said rods to said chassis.

The fixing means comprise a pair of end pieces each having a first shaped portion adapted to be removably inserted and fitted in a corresponding counter-shaped lateral seat of said chassis, each of said circles being provided with a through cut made in a corresponding counter-shaped lateral seat to allow the enlargement thereof in absence of said end pieces.

Thanks to this combination of features it will be possible to easily remove the end pieces to replace them with others of different shape or to replace the rods, without it being necessary to use specific tools to remove screws, pins or similar fastening members.

At the same time, once the end pieces have been removed, thanks to the presence of the through cuts it will be possible to easily remove one or both the lenses to perform maintenance or cleaning thereof or of the chassis or to replace them with lenses having the same shape but different optical properties.

In an exemplifying manner, it will be possible to replace one or both lenses with lenses having different gradation or suited for correcting other view defects, or, still, to replace an eye lens with a sun lens or vice versa.

The end piece, once placed again in its seat, will keeps firmly closed the frame preventing the lenses may come off the respective circles.

Advantageous embodiments of the invention are obtained in accordance with the dependent claims.

### BRIEF DISCLOSURE OF THE DRAWINGS

Further features and advantages of the invention will become more apparent in light of the detailed description of a preferred but not exclusive embodiment of a dismountable frame for glasses according to the invention, illustrated by way of non-limiting example with the aid of the accompanying drawing tables wherein:

FIG. 1 is a perspective view of the frame;

FIG. 2 is a side view of the frame of FIG. 1;

FIG. 3 is a front view of the frame of FIG. 1;

FIG. 4 is a rear view of the frame of FIG. 1;

FIG. 5 is a top view of the frame of FIG. 1;

FIG. 6 is a bottom view of the frame of FIG. 1;

FIG. 7 is a perspective view of the chassis of the frame of FIG. 1;

FIG. 8 is a rear view of the chassis of FIG. 7;

FIG. 9 is a side view of the chassis of FIG. 7;

FIG. 10 is a first perspective view of an end piece of the frame of FIG. 1;

FIG. 11 is a second perspective view of the end piece of FIG. 10;

FIG. 12 is a perspective view of a side rod of the frame of FIG. 1;

FIG. 13 is an enlarged view of a detail of the rod of FIG. 12;

FIG. 14 is a rear view of the end piece of FIG. 10;

FIG. 15 is a top view of the end piece of FIG. 10;

FIG. 16 is a bottom view of the end piece of FIG. 10;

FIG. 17 is a perspective view of a second variant of the end piece.

### BEST MODE OF CARRYING OUT THE INVENTION

With reference to the accompanying drawings there is shown a preferred but not exclusive embodiment of a glasses frame according to the invention, globally indicated with 1, which may be both designed for eyeglasses for correcting any defect of the view and for sunglasses. Moreover, as will become more apparent hereinafter, the glasses provided with the frame according to the invention may be also converted in the use, being able to be converted from eyeglasses to sunglasses or vice versa, or to be used for the correction of various defects of the view.

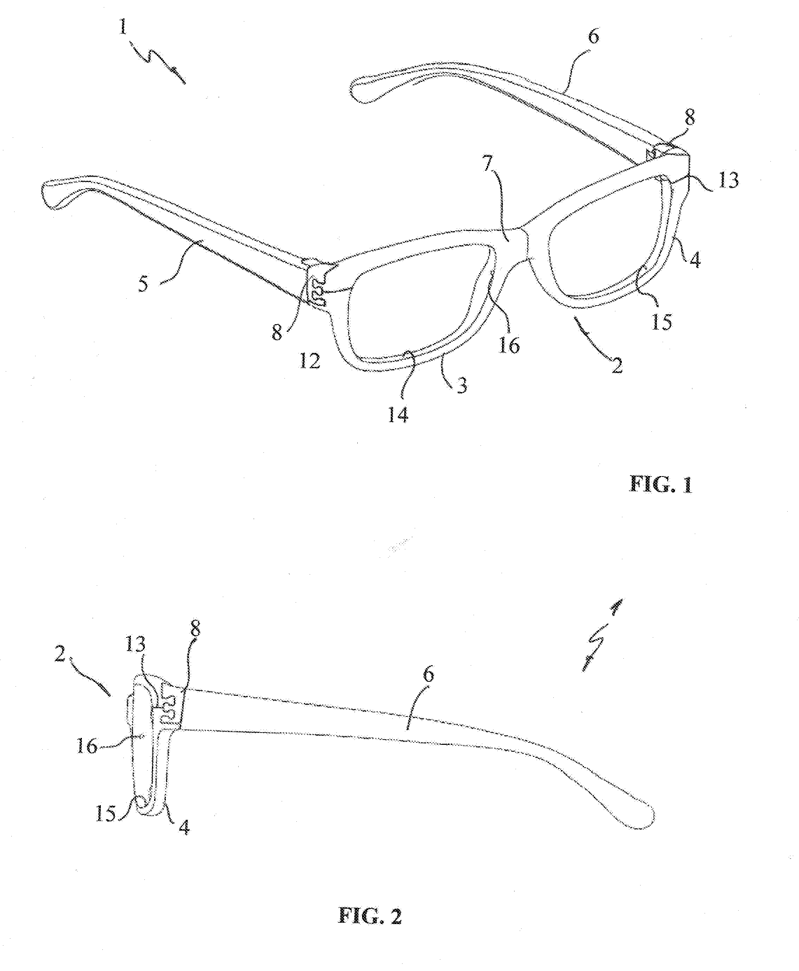

From FIG. 1 it could be observed that, in typical fashion, the frame 1 comprises a frontal chassis 2 having a pair of circles 3, 4 for housing respective lenses, not shown as known per se and not belonging to the object of the invention, a pair of rods 5, 6 mounted laterally to the chassis 2 from opposite sides of thereof and means for removably fixing the rods 5, 6 to the chassis 2.

In the shown embodiment, the chassis 2 is a unitary body with a pair of circles 3, 4 closed all along their circumference to completely surround the lenses and which are mutually joined by a central bridge 7 which in use will be placed on the nose.

The materials used for the chassis 2 and for the other parts of the frame 1 are not limiting for the present invention, both metallic materials and resins or other plastic materials being adapted to be used, as well as natural materials such as wood, bone, glass or similar, composites materials and the like.

Moreover, according to variants not shown, the chassis 2 may be formed by two circles 3, 4 distinct and joined in a separable manner from the central bridge 7, which may take different shapes and sizes depending on the model.

The aesthetic shape of the chassis 2 and in general of the various elements that will compose the frame 1 is not limiting for the present invention, being adapted to vary depending on the needs and aesthetic taste.

According to a peculiar features of the invention, the fixing means comprise a pair of end pieces 8, also defined blocks, arranged laterally with respect of the chassis 2 at respective rods 5, 6 and each having a first shaped portion 9 having jointing means 10 for the removable coupling to a corresponding counter-shaped seat 11 of the chassis 2, as more clearly visible in FIG. 2.

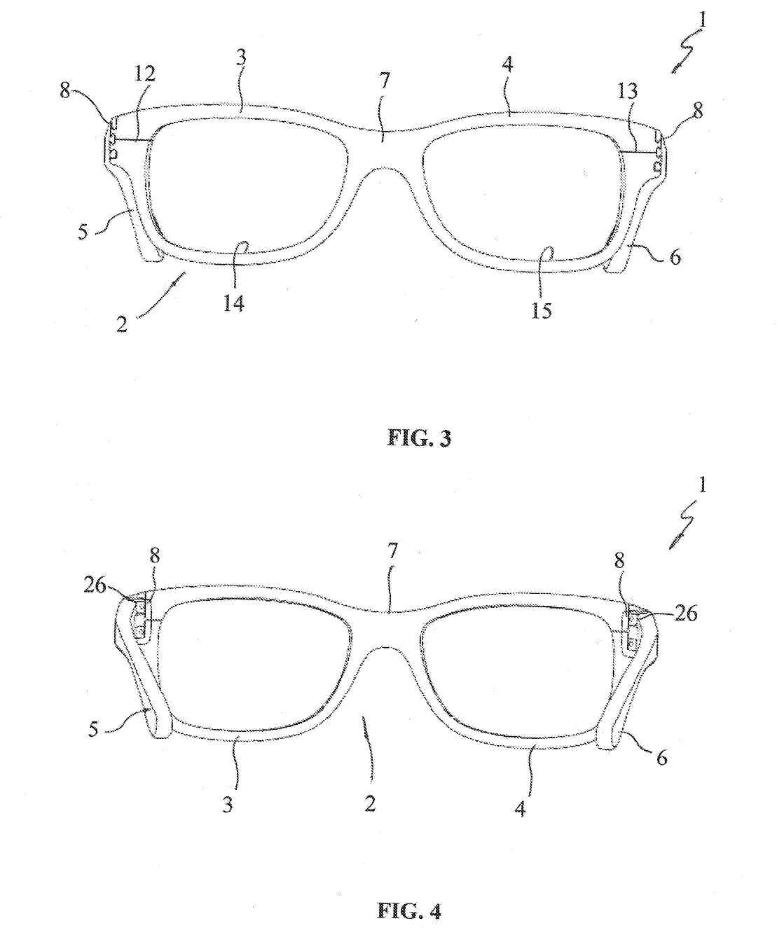

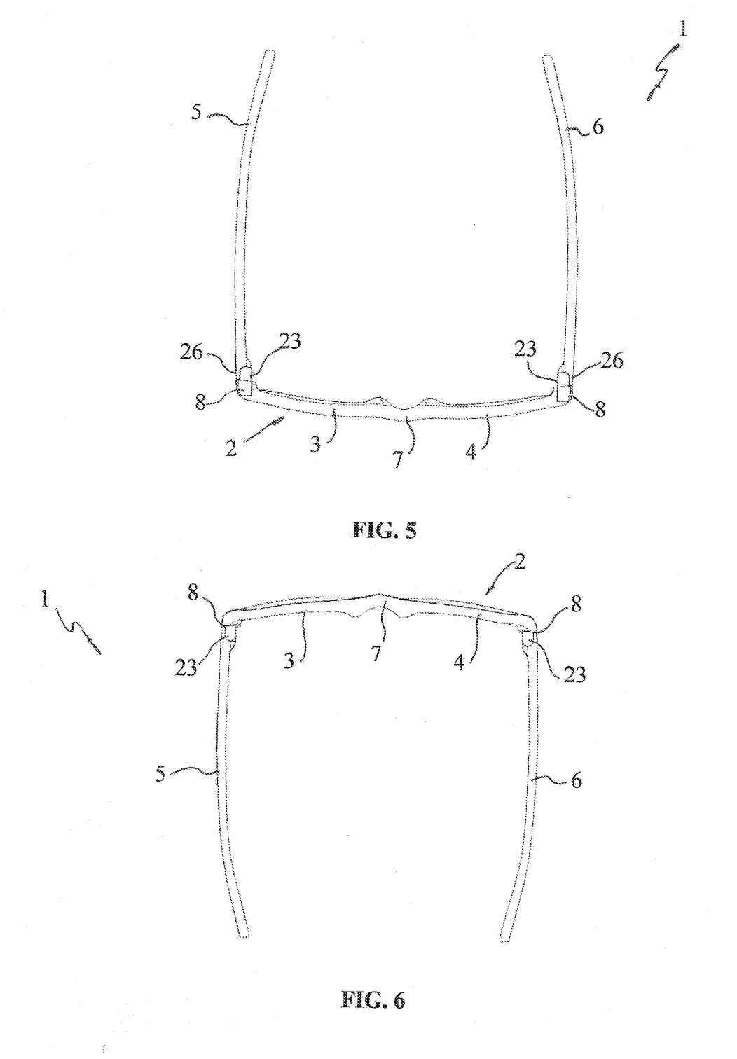

In addition, as also seen from FIGS. 3 and 4, each of the circles 3, 4 has, at the corresponding side seat 11, a through cut 12, 13 adapted to provide interruption of continuity in each of the circles 3, 4.

In this way, once the respective end piece 8 has been removed, it will be possible to cause the enlargement of the circles 3, 4, also in a separate manner from each other, with contained shifting also depending on the elasticity of the material used for the chassis 2 but sufficient to allow the unthreading of the lenses by the circles 3, 4 and the subsequent repositioning of the lens itself or a different lens but with the same shape.

Advantageously, the circles 3, 4 comprise a inner peripheral bevel 14, 15 adapted to house the edge of a respective lens.

In addition, each bevel 14, 15 has a tooth 16 radially projecting and arranged close to the bridge 7 to prevent rotation of the corresponding lens inside the bevel 14, 15 and define a reference for the right repositioning of the lenses, making the operation quicker and easier also for unskilled persons.

In a preferred but not limiting embodiment, the teeth will have dimensions less than 0.5 mm and will be wedge shaped.

The frame 1 will allow the removal and replacement of the lenses in a quick and simple manner and without requiring particular expertise, being also adapted to be carried out by non-expert personal.

As matter of fact, although it is understood that the lenses must be prescribed, delivered and processed by qualified optical staff, who will perform the required work, whether they are sunglasses or eyeglasses, by this way the positioning of the lenses in the appropriate seats defined by the circles 3, 4 will be even easier and safer for inexperienced people.

The rule book execution of the milling of the lenses according the prepared bevel, even if it is a simple and common processing, allow a precise centering, necessary for proper vision certified by regular compliance documentation.

In general, the stable but removable coupling between the end pieces 8 and the respective lateral seats 11 of the chassis 2 will be obtained associating to each end piece 8 jointing means 10 of the male and/or female type adapted to mate without the aid of fixing members such as screws, pins or the like, to the counter-shaped seat 11 provided with female and/or male means complementary shaped.

FIGS. 10 and 11 show in a greater detail a preferred but not exclusive embodiment of an end piece 8, with the other end piece that will be substantially similar and possibly specular with respect to a symmetry plane of the chassis 2 passing through the bridge 7 and orthogonal to the chassis 2.

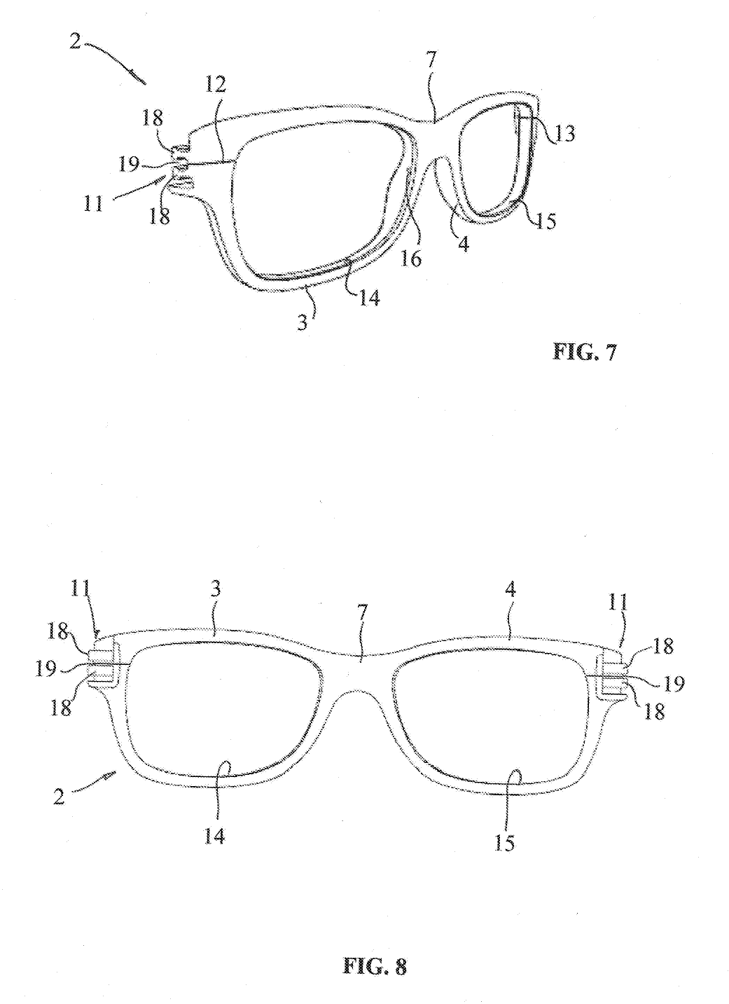

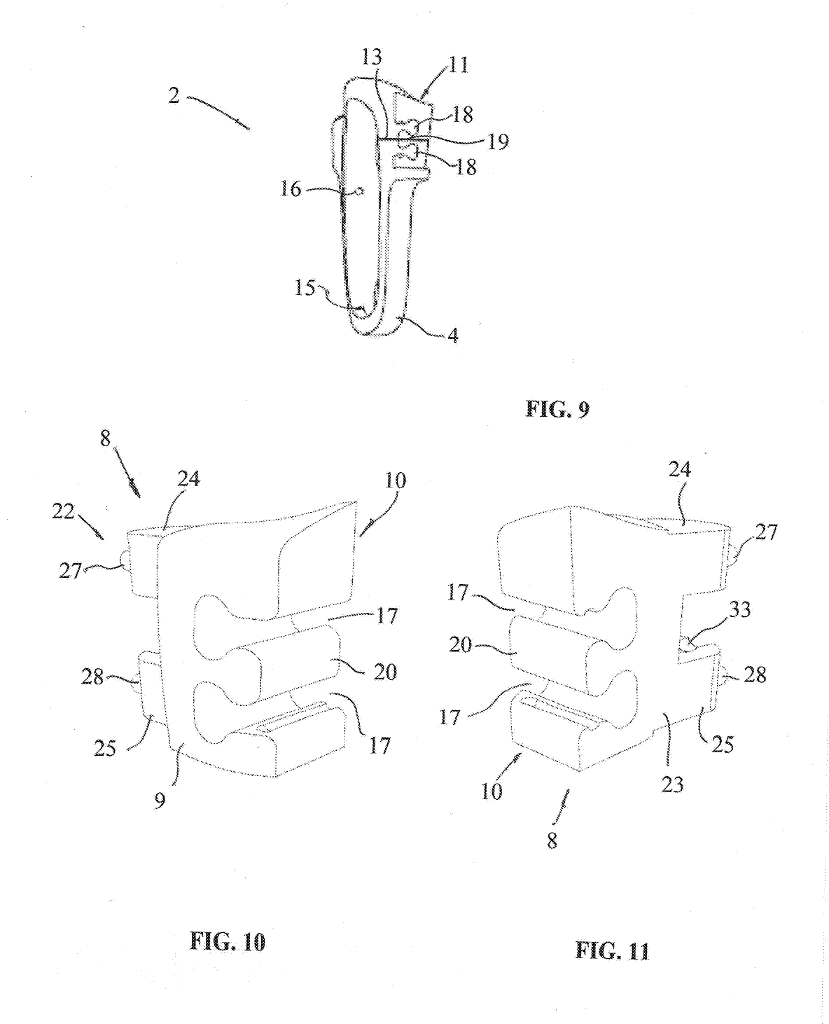

In particular, it is observed that the end piece 8 comprises a first shaped portion 9 provided with two joints 17, for example of the dovetail type with rounded edges, adapted to be coupled and to retain corresponding counter-shaped projections 18 of the side seats 11 of the chassis 2, more clearly visible in FIGS. 7 to 9.

The coupling between the end pieces 8 and the chassis 2 may be obtained by sliding the male protrusions 19 of the lateral seats 11 inside the female joints 17 of the respective end pieces 8. Alternatively, it will be possible to snap couple the end pieces 8 inside the respective lateral seats 11 thanks to the fact that the joints 17 of the end pieces 8 and the projections 18 of the lateral counter-shaped seats 11 have respective mutually facing edges suitably bevelled.

Conveniently, the through cuts 12, 13 will be realized between the two projections 18 of the lateral seats 11 so as to be arranged in correspondence with a central recess 19 which will be engaged by a corresponding projection 20 of complementary shape made in the nose 8 and interposed between the two joints 17.

FIG. 17 shows a variant of the end piece 8 wherein the joints 17 each include a retainer 21 adapted to be inserted in a corresponding recess, not visible, made on the respective counter-shaped protrusion 18 so as to drive the coupling and indicate the correct position assembly, also preventing the end piece 8 to move as a result of mild stresses.

According to yet another variant, not shown, the retainer 21 can be realized on the projections 18 of the lateral seats 11 while the joints 17 of the end pieces 8 will be provided with complementarily shaped recesses.

Each end piece 8 also comprises means 22 for removably anchoring a respective rod 5, 6, which may be designed to allow or not the rotation.

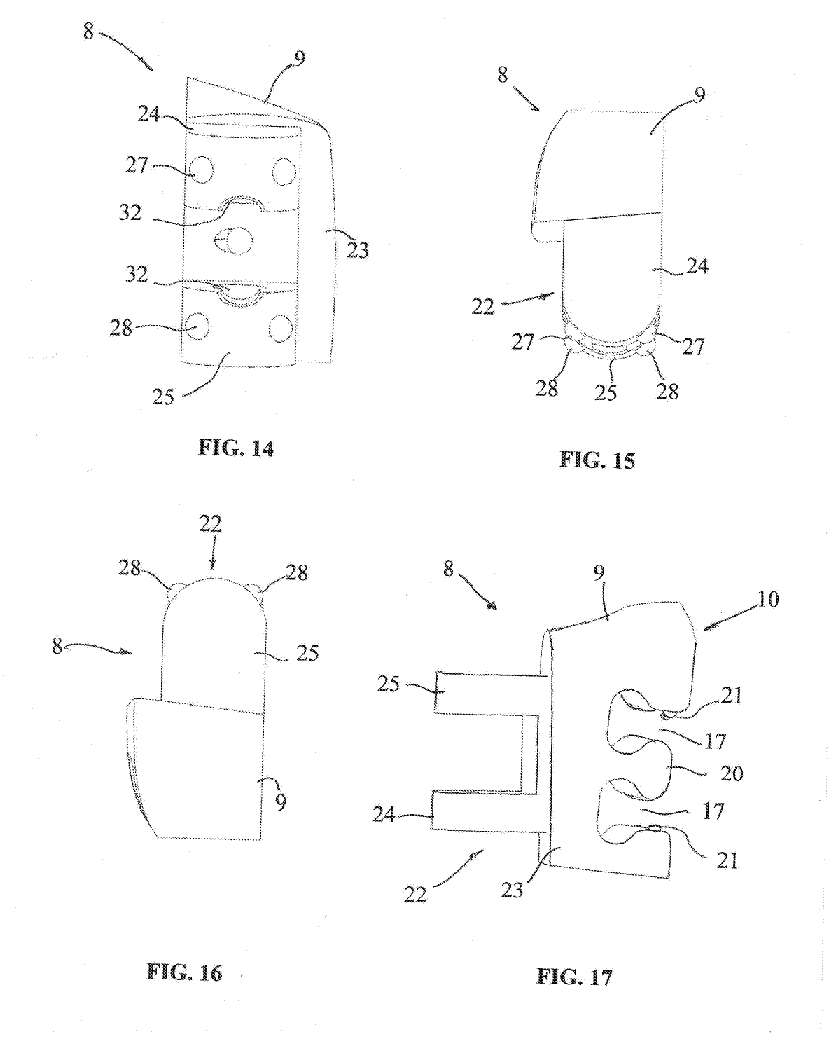

In the preferred but not exclusive shown embodiment, visible in greater detail in FIGS. 14 to 16, the anchoring means 22 are of the hinge type and are adapted to allow the rotation of the rods 5, 6, preferably with maximum rotation angle at least equal to 90°.

In particular, each end piece 8 comprises a second shaped portion 23 adapted to be removably coupled to one counter shaped end of the respective rod 5, 6.

The second shaped portion 23 comprises a pair of flanges 24, 25 which extend along a direction substantially orthogonal to the chassis 2.

Similarly, the rods 5, 6 have at one end a coupling element 26 complementarily shaped to the second shaped portion 23 of the corresponding end piece 8.

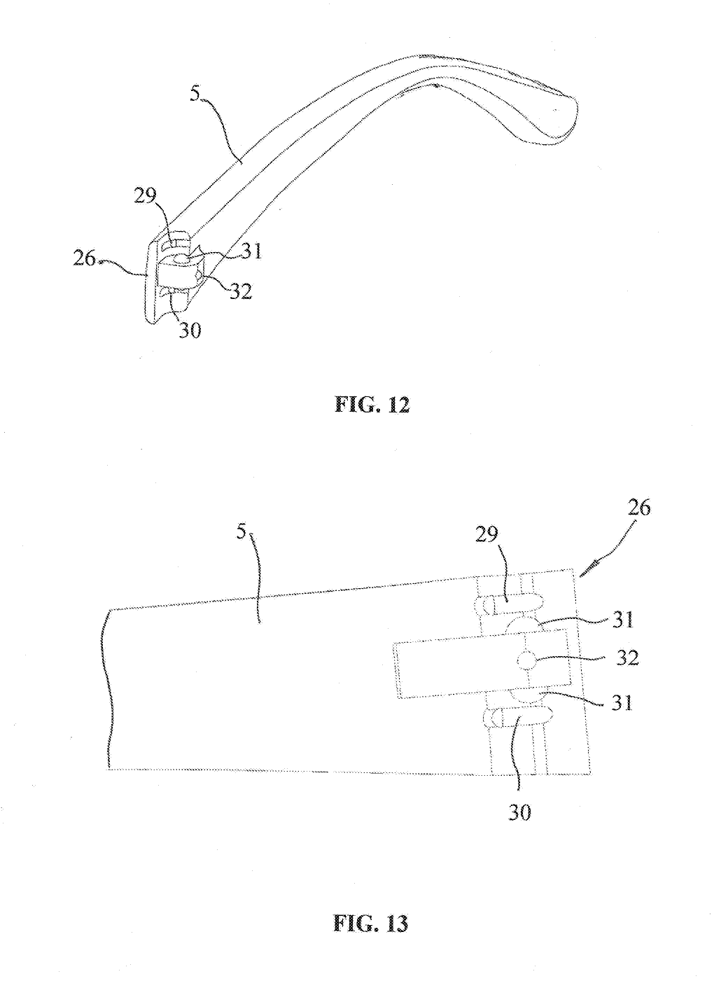

In the illustrated embodiment, exemplificative but not limiting the invention, the end pieces 8 comprise, for each flange 24, 25, a pair of protuberances 27, 28 designed to engage corresponding grooves 29, 30 provided in the rods 5, 6, as most clearly visible in FIGS. 12 and 13.

Similarly, the rods 5, 6 further comprise protuberances 31, 32 adapted to engage corresponding recesses 33 of the end pieces 8 to facilitate the mutual rotation and exert a minimum restraining force which prevents involuntary opening or closing movements.

According to a not shown variant, the flanges 24, 25 may be provided with respective through holes defining a transverse passage adapted to be aligned with a further transverse hole of the rod 5, 6 for inserting a pin, a screw or similar element defining a hinge axis and having a structure known per sè.

The frame 1 will be dismountable and customizable in all its components, and it could be possible to vary the materials, the shape and the colours of the various elements independently from each other to have a multiplicity of possible combinations, but always ensuring, with the frame assembled, homogeneity and continuity between the elements.

The frame 1 may be manufactured according to any known technique, such as moulding, injection, milling or other typical processing.

From above it is clear that the frame according to the invention achieves the intended objects. The frame according to the invention is susceptible of numerous modifications and variations, all falling within the inventive concept expressed in the accompanying claims. All the details may furthermore be replaced with other technically equivalent elements, and the materials may be different according to requirements, without departing from the scope of protection of the present invention.

1. A dismountable frame for glasses, comprising:
a frontal chassis (2) having a pair of circles (3, 4) for housing respective lenses;
a pair of rods (5, 6) mounted laterally to said chassis (2) from opposite sides with respect thereto;
means for removably fixing said rods (5, 6) to said chassis (2);
characterized in that said fixing means comprise a pair of end pieces (8) each having a first shaped portion (9) with jointing means (10) adapted to be removably inserted and fitted in corresponding counter-shaped lateral seats (11) of said chassis (2), the latter being provided with a pair of through cuts (12, 13) made in each of said lateral counter-shaped seats (11) to allow the enlargement of said circles (3, 4) in the absence of said end pieces (8).

2. Frame as claimed in claim 1, characterized in that said jointing means (10) comprise, for each of said end pieces (8), two or more joints (17) of dovetail type or the like adapted to be coupled and to retain corresponding counter-shaped projections (18) of said lateral seats (11) of said chassis (2).

3. Frame as claimed in claim 2, characterized in that each of said joints (17) comprises a stop (21) adapted to be inserted into a corresponding recess made on said complementarily shaped projections (18).

4. Frame as claimed in claim 3, characterized in that said joints (17) and said complementarily shaped projections (18) have respective mutually facing chamfered edges to facilitate the mutual snap coupling, making the operation more quick, precise and easy even for unskilled personnel.

5. Frame as claimed in any preceding claim, characterized in that each of said end pieces (8) comprises means (22) for removably anchoring a respective one of said rods (5, 6).

6. Frame as claimed in claim 4, characterized in that said anchoring means (22) are of the hinged type and adapted to allow the rotation of said rods (5, 6).

7. Frame as claimed in claim 5, characterized in that said hinge anchoring means (22) comprise a second shaped portion (23) removably coupled to a counter-shaped end of the respective rod (5, 6).

8. Frame as claimed in claim 5, characterized in that for each of said end pieces (8) said second shaped portion (23) has a transverse passage adapted to be aligned with a transverse hole made in said end of the respective one of said rods (5, 6) for inserting a pin, a screw or similar element defining a hinge axis.

9. Frame as claimed in any preceding claim, characterized in that each of said circles (3, 4) of said chassis (2) comprises an inner peripheral bevel (14, 15) for housing the peripheral edge of a respective lens.

10. Frame as claimed in claim 9, characterized in that said peripheral bevels (14, 15) have each a tooth (16) radially projecting and adapted to prevent the rotation of the corresponding lens.

11. Frame as claimed in any preceding claim, characterized in that said chassis (2) is made as unitary body with a pair of circles (3, 4) closed all along their perimeter and mutually joined by a central bridge (7).
